(19) United States
(12) Patent Application Publication
(10) Pub. No.: US 2008/0049372 A1
(43) Pub. Date: Feb. 28, 2008

(54) THREE-DIMENSIONAL ELECTROMAGNETIC FLUX FIELD GENERATION

(75) Inventor: Siew Ling Loke, London (GB)

Correspondence Address: KNOBBE MARTENS OLSON & BEAR LLP, 2040 MAIN STREET, FOURTEENTH FLOOR, IRVINE, CA, 92614, US

(73) Assignee: Bio Aim Technologies Holding Ltd., Tortola (VG)

(21) Appl. No.: 11/844,246

(22) Filed: Aug. 23, 2007

Related U.S. Application Data
(60) Provisional application No. 60/839,480, filed on Aug. 23, 2006.
(60) Provisional application No. 60/950,192, filed on Jul. 17, 2007.

(51) Int. Cl. H01H 47/00; H02J 7/00

(52) U.S. Cl. 361/143; 320/108

(57) ABSTRACT

A base system generates a three-dimensional magnetic flux field using, for example, a uniquely shaped magnetic material and winding arrangements that generate multi-frequency multi-directional fields such that their vector sum is the resultant of a power transference surface that sweeps three-dimensionally within the designated area. When a floating coil or winding arrangement together with the appropriate circuitry is placed in the vicinity of the field, the coupling and induction effect produces a current that flows in the conductor that forms the coil. Power can then be successfully transferred bounded by the resultant field regardless of its orientation or height. With the proliferation of Digital Signal Processing (DSP) technology in the Switched-Mode Power Supplies (SMPS) area, the electromagnetic fields can be controlled independently and therefore adaptive control becomes more feasible. This increases the benefits of three-dimensional magnetic flux generation.

### CROSS-REFERENCE TO RELATED APPLICATIONS

This application claims the benefit under 35 U.S.C. §119(e) of U.S. Provisional Application No. 60/839,480, filed Aug. 23, 2006, and U.S. Provisional Application No. 60/950,192, filed Jul. 17, 2007, the entireties of which are hereby incorporated by reference.

This application is related to copending application entitled SYSTEMS AND METHODS FOR WIRELESS POWER TRANSFER, Ser. No. ______ [Attorney Docket No. RAIF.003A], filed on the same date as the present application, the entirety of which is hereby incorporated by reference.

### BACKGROUND OF THE INVENTION

1. Field of the Invention

The invention generally relates to electronics, and in particular, to wireless charging.

2. Description of the Related Art

Portable devices has proliferated over the past ten years. For the purpose of cost and convenience these devices rely on secondary power cells which can be recharged for example laptop computers, mobile telephones, electrical toothbrushes, shavers and personal digital assistant. Many of these devices are charged via electrical contacts and power supplies that take power from the mains and convert into a level suitable for each individual device.

Conventional techniques for power conversion and electrical connection vary considerable from manufacturer to manufacturer. Therefore, for consumers who own several of these devices are required to own or carry around several different types of adaptors which can be cumbersome when traveling or trying to find enough sockets to plug them into. Moreover, these devices have open electrical contacts that can be damaged in water or exposed to other chemicals and therefore inappropriate to be used by hard wearing users. In recent years, some attempts have been made to overcome the foreseeable problems.

Inductive transference of energy or power has been used for many years in the form of transformers in switched mode power supplies. They include a primary circuit that generates electromagnetic flux field and fixed secondary circuits those receive inductively coupled power.

Wireless power transfer has become a very attractive solution with the proliferation of portable devices over the past ten years. With these devices for instant mobile phones, toothbrushes, PDA or laptop computers reliant on rechargeable secondary powered cells, it may not always be convenient or safe to have open electrical contacts. The wireless connection provides a number of advantages over conventional hardwired connections. A wireless connection can reduce the chance of shock and can provide a relatively high level of electrical isolation between the power supply circuit and the secondary circuit. Inductive couplings can also make it easier for a consumer to replace limited-life components. Secondary devices can be completely sealed to ensure safety when used in damp or wet surroundings for example bathroom, kitchen or even swimming pool. This wireless solution is not only limited to portable devices. Many devices like game consoles, DECT phones or even a lamp can benefit from cutting the cords. As there many wireless communication platforms that already exist or upcoming like Bluetooth, NFC, WIFI, UWB, GSM etc., the only physical connection left is the power supply.

Wireless inductive charging of portable devices is divided into two categories. The first category is indirect charging, where the wireless electronics supplies power to secondary of the charging circuitry of a portable device which in turn will charge its battery accordingly. The second category is direct charging, where the secondary of the wireless inductive charging electronics are connected (contacted) to the battery directly supplying the charging current. Direct charging is typically more efficient as it has less circuitry for power loss to occur. However, direct charging is physically difficult to implement using wireless technology on existing portable devices. Many portable or handheld devices are built to a compact specification. Portable devices typically do not have room for any additional circuitry.

Prior techniques of non-contact battery charging include a technique whereby an inductive coil on the primary side aligns with a horizontal inductive coil on a secondary device when the device is placed into a cavity on the primary side that ensures precision in the alignment, which is crucial to achieving effective power transfer. A device that uses this technique includes the Braun Oral B Plak Control toothbrush. However, this system requires the secondary devices to be axially aligned with the primary unit. Existing wireless chargers are typically also uniquely designed by each individual manufacturer and typically cannot be used interchangeably.

Examples of wireless power transfer include U.S. Pat. No. 3,938,018 to Dahl; U.S. Pat. No. 5,959,433 to Rohde; U.S. Pat. No. 4,873,677 to Sakamoto, et al.; U.S. Pat. No. 5,952,814 to Van Lerberghe; U.S. Pat. No. 6,208,115 to Binder; WO 00/61400; WO 95/11545; GB2399225; GB2399226; GB2399227; GB2399228; GB2399229; GB2399230; U.S. Pat. No. 5,519,262 to Wood; U.S. Pat. No. 5,703,461 to Minoshima, et al.; U.S. Pat. No. 6,906,495 to Cheng, et al.; U.S. Pat. No. 7,123,450 to Baarman, et al.; U.S. Pat. No. 4,675,615 to Bramanti; U.S. Pat. No. 5,952,814 to Van Lerberghe; U.S. Pat. No. 7,211,986 B1 to Flowerdew et al.; and U.S. Pat. No. 7,215,096 B2 to Miura et al.

### SUMMARY OF THE INVENTION

One embodiment includes a base system that generates a three-dimensional magnetic flux field using a uniquely shaped magnetic material and winding arrangements that generate multi-frequency multi-directional fields for charging of a mobile device. These fields can be such that their vector sum is the resultant of a power transference surface that sweeps three-dimensionally within the designated area. When a floating coil or winding arrangement together with the appropriate circuitry is placed in the vicinity of the field, the coupling and induction effect produces a current that flows in the conductor that forms the coil. Power can then be successfully transferred bounded by the resultant field regardless of its orientation or height. With the proliferation of Digital Signal Processing (DSP) technology in the Switched-Mode Power Supplies (SMPS) area, the electromagnetic fields can be controlled independently and therefore adaptive control becomes more feasible. This increases the benefits of three-dimensional magnetic flux generation.

One embodiment is an apparatus for providing wireless charging over a 3-dimensional space, wherein the apparatus includes: at least 3 separate conductive windings, wherein each of the at least 3 separate conducive windings is configured to carry a separate electrical current for generation of a magnetic flux field over the 3-dimensional space; and a control circuit coupled to the at least 3 separate conductive windings, the control circuit configured to generate at least 3 time-varying currents to be carried by the at least 3 separate conductive windings, wherein each of the at least 3 time-varying currents is operated at a different frequency from each other.

One embodiment is a method for providing wireless charging over a 3-dimensional space, wherein the method includes: providing at least 3 separate conductive windings, wherein each of the at least 3 separate conducive windings is configured to carry a separate electrical current for generation of a magnetic flux field over the 3-dimensional space; and generating at least 3 time-varying currents for the at least 3 separate conductive windings, wherein each of the at least 3 time-varying currents is operated at a different frequency from each other.

### BRIEF DESCRIPTION OF THE DRAWINGS

These drawings and the associated description herein are provided to illustrate specific embodiments of the invention and are not intended to be limiting.

FIG. 1 illustrates three planes in 3-D space for which a generated magnetic field in 3-D space will be a vector sum.

FIG. 2 illustrates an example of generating magnetic flux fields of disparate frequencies for each plane, wherein each of the waveforms is pulsed.

FIG. 3 illustrates an example of generating magnetic flux fields of disparate frequencies for each plane, wherein each of the waveforms is sinusoidal.

FIG. 4 illustrates a 3-D plot of a vector sum of the flux lines corresponding to the waveforms of FIG. 3.

FIG. 5 illustrates a 3-D plot of a vector sum of the flux lines with varying amplitudes for flux fields.

FIG. 6 illustrates a magnetic field generated by passing current through a conductor.

FIG. 7 illustrates a secondary circuit that can be used by a mobile device or a battery for charging from a base station with a primary circuit.

FIGS. 8A, 8B, and 8C illustrate examples of possible winding configurations for 3-D flux field generation.

FIG. 9 depicts an example of a fly-back converter topology with a magnetic amplifier.

FIG. 10 illustrates an example of operation without the magnetic amplifier.

FIG. 11 illustrates an example of a charging profile.

FIG. 12 illustrates an example of operation of the fly-back converter topology.

FIG. 13 illustrates a circuit for reset of the magnetic amplifier.

FIG. 14 illustrates an example of an electronic post regulating circuit, which can be used in place of a magnetic amplifier.

### DETAILED DESCRIPTION OF PREFERRED EMBODIMENTS

An application for the three-dimensional wireless inductive power transfer system is battery charging. Contact-less power transfer is achieved through magnetic induction. A novel winding technique is presented in the primary or the base unit, wherein a unique winding arrangement will enable a secondary floating unit to be placed in the vicinity of the flux field for the power transference to occur.

One feature of the base unit is that the field lines describing the generated magnetic fields are distributed in three dimensions over the charging area when the base unit is in effective magnetic isolation, that is, when there are no secondary or floating devices present within the proximity of the primary unit.

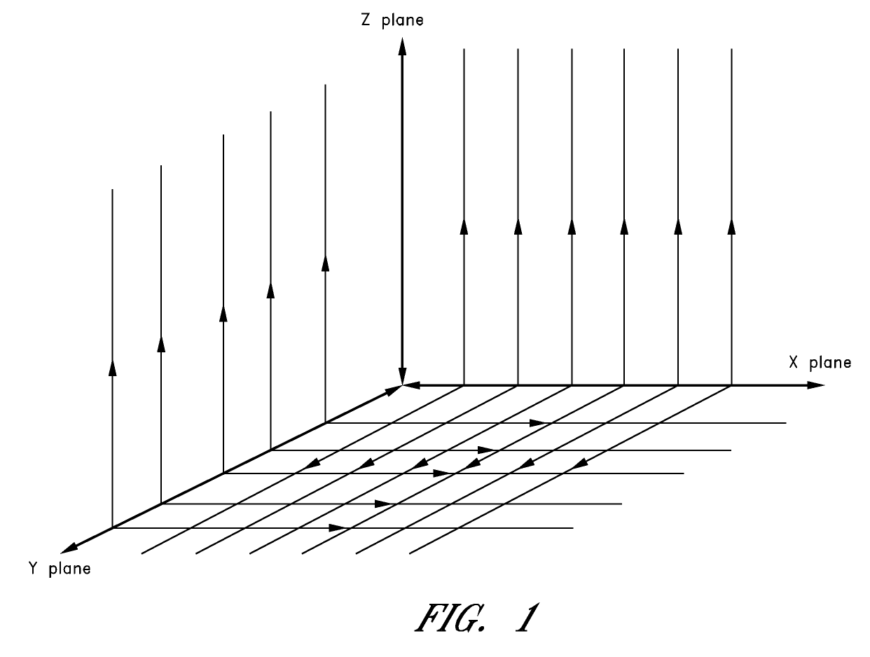

The three-dimensional rotating magnetic field comprises at least three magnetic flux fields that are displaced approximately at right angles with respect to one another and in variable frequencies in the X, Y, and Z plane as shown in FIG. 1 by a generating coil wound around the high-permeability core, e.g., ferrite core, nanocrystalline core, powdered iron core, ferromagnetic material, etc.. In one embodiment, the relative permeability of the material used in the core is at least 20. The resulting magnetic field is a vector sum of the three fields that are different in both phase and frequency, both of which are time varying in one embodiment. Therefore, the final propagating magnetic field sweeps across the three dimension charging area so that at a wide range of points on the charging area, the measured magnetic flux field is relatively uniform regardless of the orientation of the measuring device.

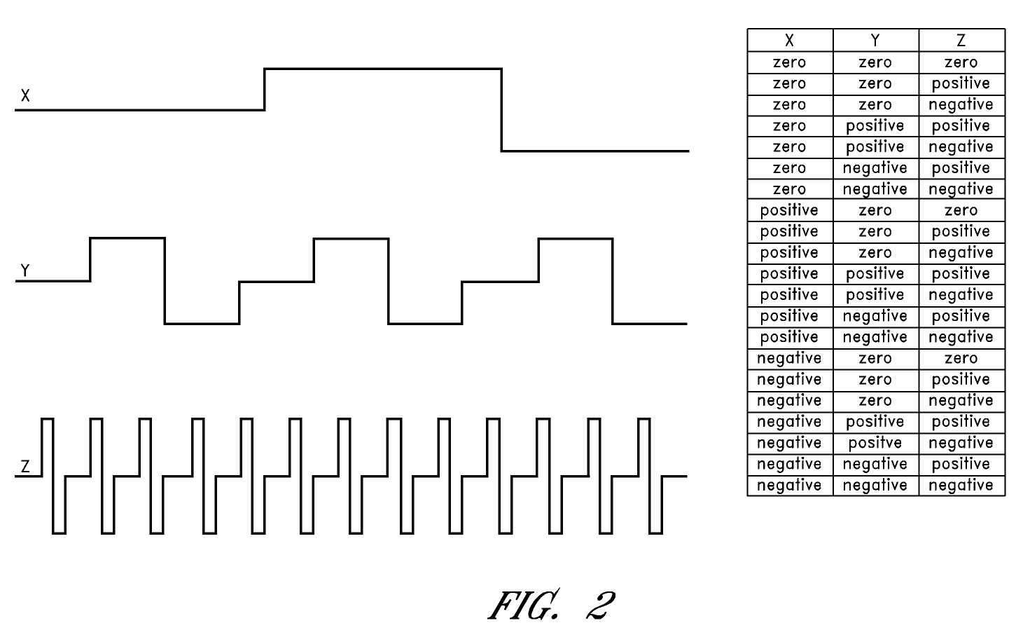

To demonstrate the theory of three-dimensional flux generation, xyz coordinates that represent the different planes of a three-dimension are used. The table of FIG. 2 shows an example of a possible combination of directional coordinates that electromagnetic flux field can appear within a three dimension domain. Re-plotting these coordinates as waveforms, shows three waveforms with variable frequency. In the illustrated example, plane X displays the fundamental frequency, plane Y is three times the fundamental frequency and plane Z is nine times the fundamental frequency. It will be understood that the frequencies can be allocated differently among the planes. A very broad range of frequencies can apply to the fundamental frequency. For example, the fundamental frequency can be between 10 kilohertz and 1 megahertz. In one embodiment, the fundamental frequency is at least 25 kilohertz such that the fundamental frequency is outside the human hearing range. To achieve a three-dimensional electromagnetic flux sweep in one given domain, three separate electromagnetic fields in progressive harmonics of the other are propagated at the same time in their respective planes. When this happens, the flux rotates through the possible coordinates extending from the origin.

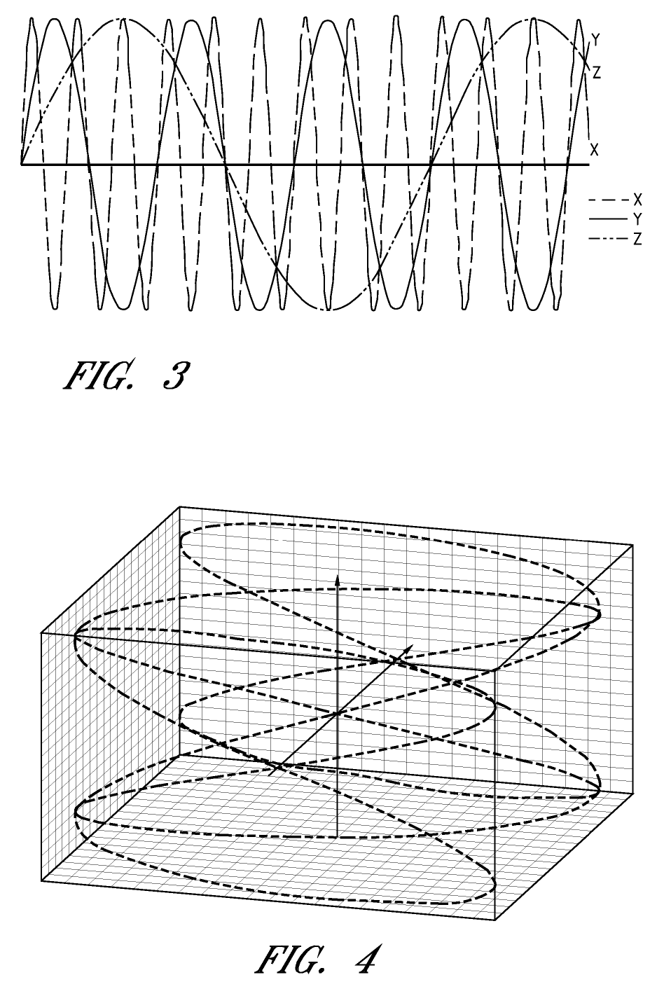

As illustrated in FIG. 3, sinusoidal waveforms can alternatively be used instead of the pulsed waveforms. The sinusoidal waveforms can improve the uniformity of the three-dimensional electromagnetic flux sweep. A combination of pulsed waveforms and sinusoidal waveforms can also be used.

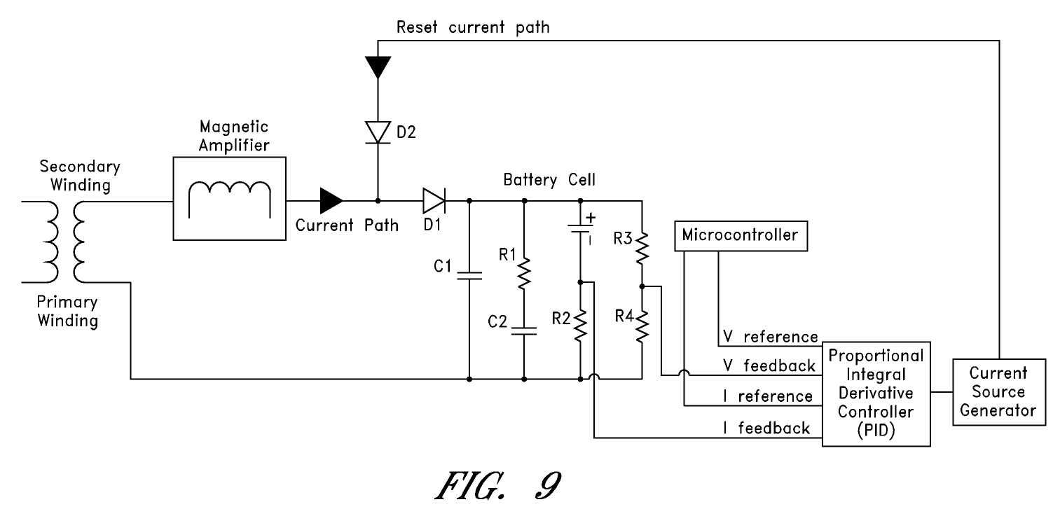

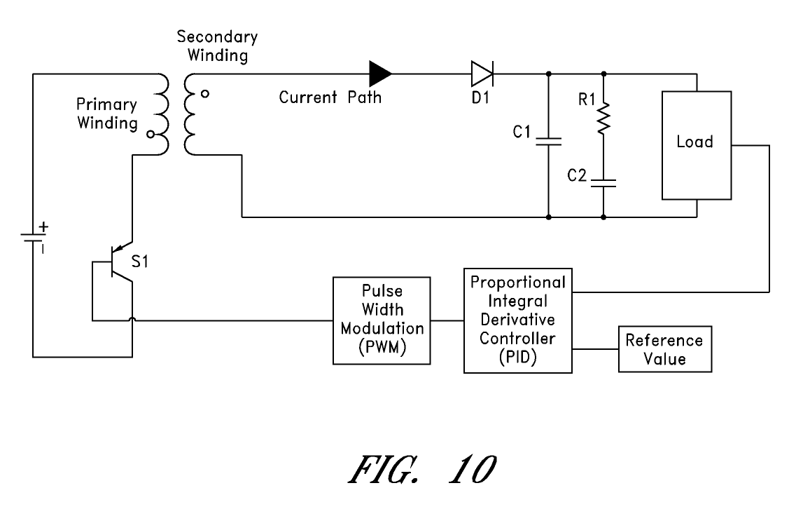

FIG. 4 shows a three-dimensional plot of flux lines (per unit value) resulting from a vector sum of the waveforms illustrated in FIG. 3 as applied to the windings illustrated in FIG. 8c. The plot represents the magnitude and direction for the electromagnetic flux, as indicated by a vector from the origin to a point on the plot, and in this case reaches the eight quadrants in a three-dimension domain. FIG. 4 illustrates that as long as there are at least three electromagnetic flux fields of different frequency and phase, a generation of three-dimensional flux can be achieved.

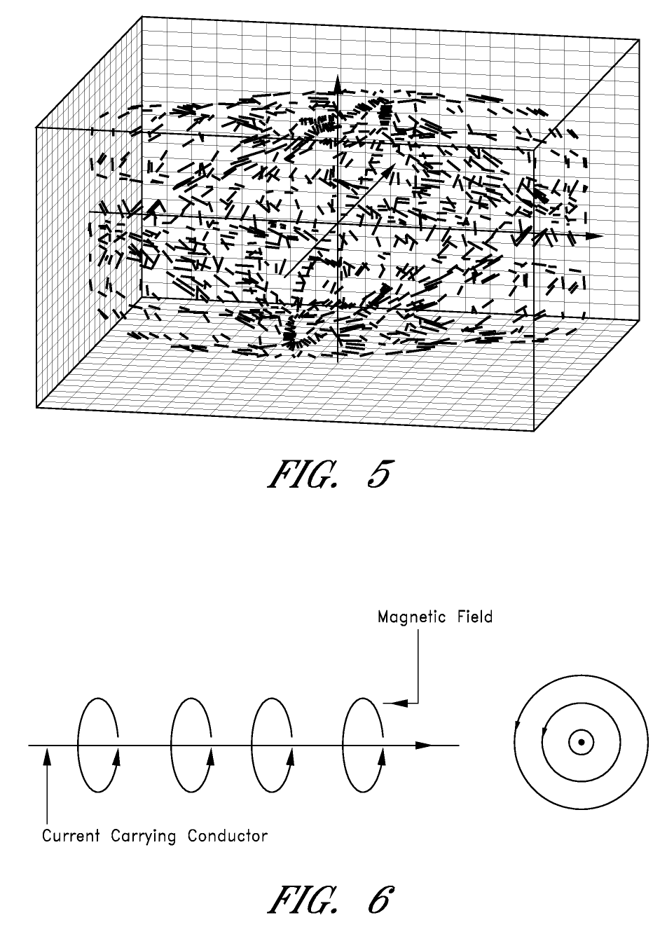

In one embodiment, the amplitude of one or more of the generated electromagnetic fields is varied. Varying the amplitude can affect the range over which a sufficient flux field for charging devices can be generated. FIG. 5 illustrates an example of the resulting vector sums of the flux lines with variations in amplitude.

When electric current flows through a conductor (such as copper wire), the current generates a magnetic field. The magnetic field is strongest at the conductor surface and weakens as distance from the conductor surface is increased. The magnetic field is perpendicular to the direction of current flow and its direction is illustrated by use of the right hand rule as shown in FIG. 6.

When a conductor or wire is wound around a permeable material, such as ferrite, iron, steel, moly-permalloy powder (MPP), such as MPP THINZ™ high flux, etc, and current flows through the conductor, a flux is induced on the magnetic materials. This flux is induced by the magnetic field generated by the current carrying conductor. The intensity of this flux is called flux density. When a second wound core is placed in the vicinity of the flux field, energy is transferred to this secondary current carrying conductor. Inductive coupling is used to transfer energy from primary to the secondary unit. An example of inductive coupling can be found in a transformer.

The permeability of a magnetic material is the ability of the material to increase the flux density within the material when an magnetic field is applied to the material by, for example, an electric current flowing through a conductor wrapped around the magnetic materials providing the magnetization force. The higher the permeability, the higher the flux densities from a given magnetization force. Therefore, magnetic materials with a relatively high permeability will typically be more effective as the magnetic field strength diminishes over distance making three-dimension flux transfer within a limited range practical. Moreover a relatively high permeability also gives the flexibility in the power circuit design as a wide range of bandwidths of frequencies and a wide range of voltages can be used. A suitable magnetic material with high permeability is nanocrystalline. It is a soft magnetic material where the composition is 82% iron with the remaining balance silicon, boron, niobium, copper, carbon, molybdenum, and nickel. The raw material is manufactured and supplied in an amorphous state. It is re-crystallized into a precise mix of amorphous and nanocrystalline phases when annealed, giving the material its unique magnetic properties making them more favorable in the design of three-dimensional power transfer.

There are many power converter topologies that can be used for providing current to the windings of the base unit. Examples of power converter topologies include the fly-back converter, forward converter, half bridge, full bridge, and the like. There are of course trade-offs among them for instances; component count, efficiency and the ease of implementation for this particular configuration of controlling a minimum of three windings.

In one embodiment, a three-phase converter with a centre-tapped neutral so that the individual legs can be independently controlled by a DSP controller is used. This configuration provides a relatively low component count and a relatively high efficiency of power transfer. Using pulse-width modulation (PWM) techniques together with averaging chokes (inductors), the controller is able to achieve variation in amplitudes, frequencies and as well as phase in the output waveforms to generate the electromagnetic fields.

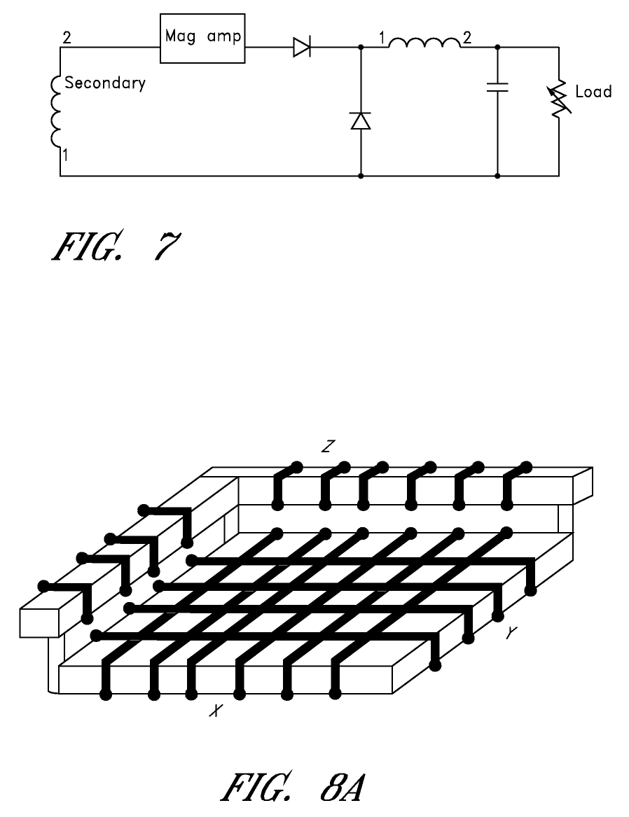

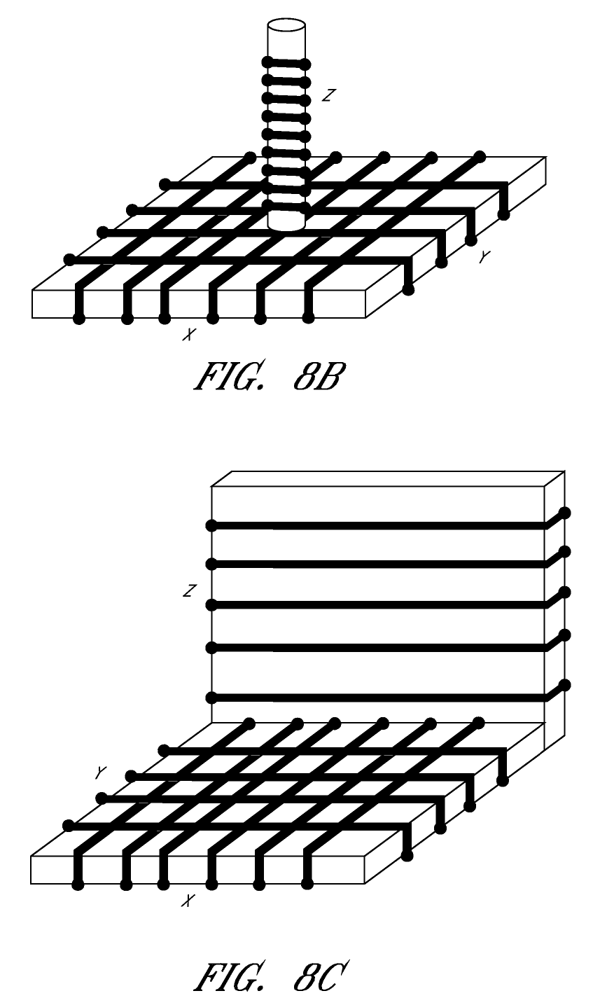

The secondary unit (floating) can be installed in or incorporated with various types of portable devices. The secondary unit can include a magnetic amplifier (mag amp), a rectifying circuit, microcontroller and a current source circuit as shown in FIG. 7. The magnetic amplifier can be, for example, a saturable reactor (inductor). With the assistance an adaptive control technique namely parameter scheduling, the microcontroller can be pre-programmed with a suitable set of parameters to determine the required characteristic of individual battery types. The magnetic amplifier permits individualized control of the charging for a particular device or battery to be charged.

FIGS. 8A, 8B, and 8C illustrate examples of possible winding configurations for embodiments of the invention. The windings produces the flux in their respective X, Y and Z planes. It will be understood that these examples are not exhaustive.

One embodiment of the invention depicts inductive wireless power transfer. Inductive transference of energy or power includes a primary circuit that generates an electromagnetic flux field and one or more secondary circuits that receive inductively coupled power. In typical non-wireless power supplies, one secondary output voltage is regulated closed-loop to the primary, while other secondaries remain open loop. With a single primary for generating the electromagnetic flux field, e.g., the charging surface, there can be multiple secondaries when charging more than one device at a time. In addition to this, a conventional non-wireless feedback mechanism uses a wired connection, which is not feasible in a wireless environment.

Although feedback can be provided via a wireless communications technique, such as Bluetooth or NFC, this will typically reduce the available bandwidth desired for relatively good control performance. Moreover, as mentioned before, multiple secondary closed-loop control is not feasible using this strategy. In one embodiment of the invention, a magnetic amplifier, which is a type of saturable reactor or saturable inductor, is introduced into the design of the secondary charging circuitry. The magnetic amplifier offers a low cost regulation principle that is efficient, closed-loop and yet independent of the primary. By employing parameter scheduling adaptive control technique together with the magnetic amplifier, it is possible create a universal charging circuitry for wireless inductive battery charging.

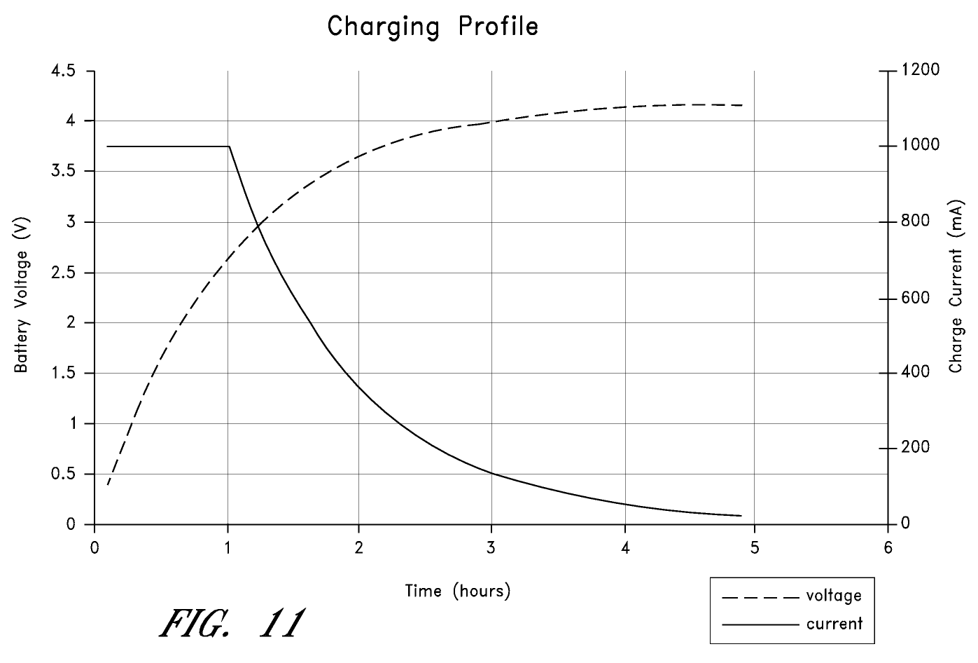

FIG. 9 illustrates an embodiment of the invention of a secondary side of a wireless charging circuit that can be embedded with a battery or battery pack. The illustrated embodiment includes a coil winding, a magnetic amplifier, transformer isolated converter configuration. FIG. 9 illustrates a Fly-back converter topology together with their driving circuitries, diodes, output low-pass filter and a microcontroller. The embodiments described in this disclosure have the circuitries and windings integrated in the batteries or battery packs. For example, in one embodiment, it is incorporated with lithium polymer battery cells to form the integrated batteries or battery packs.

FIG. 9 depicts a fly-back converter together with a magnetic amplifier and control circuitries that is capable of performing closed loop control within the secondary for charging a battery cell wirelessly. D1 is a diode used for rectification. Cl is an output filter capacitor. R1 and C2 provide resonant damping. R2, which is connected in series with a battery cell, is used to sense the charging current for feedback control. R3 and R4 form a voltage divider circuit to sense the battery voltage for the voltage feedback. The microcontroller can provide reference values typically determined by the device manufacturer or by the battery manufacturer for an individual battery requirements. In one embodiment, these reference values are preprogrammed. With the use of a Proportional Integral Derivative (PID) Controller, a control value will be used by the current source generator to produce a reset current that is injected in the opposite direction to the original current path to control the pulse width of the magnetic amplifier.

The principles of operation of this embodiment will initially be described without the magnetic amplifier as shown in the model of FIG. 10. The illustrated circuit model behaves like the secondary of a fly-back converter. Alternating magnetic flux fields are picked up by the coil during wireless power transfer and converted into an alternating voltage source. This voltage is then rectified by a diode D1, e.g., a Schottky diode, and then filtered by capacitor C1 to obtain a DC voltage output which is then used to charge a battery. This configuration is used in a wired design where the feedback control is used to directly control the pulse-width of the primary switch S1.

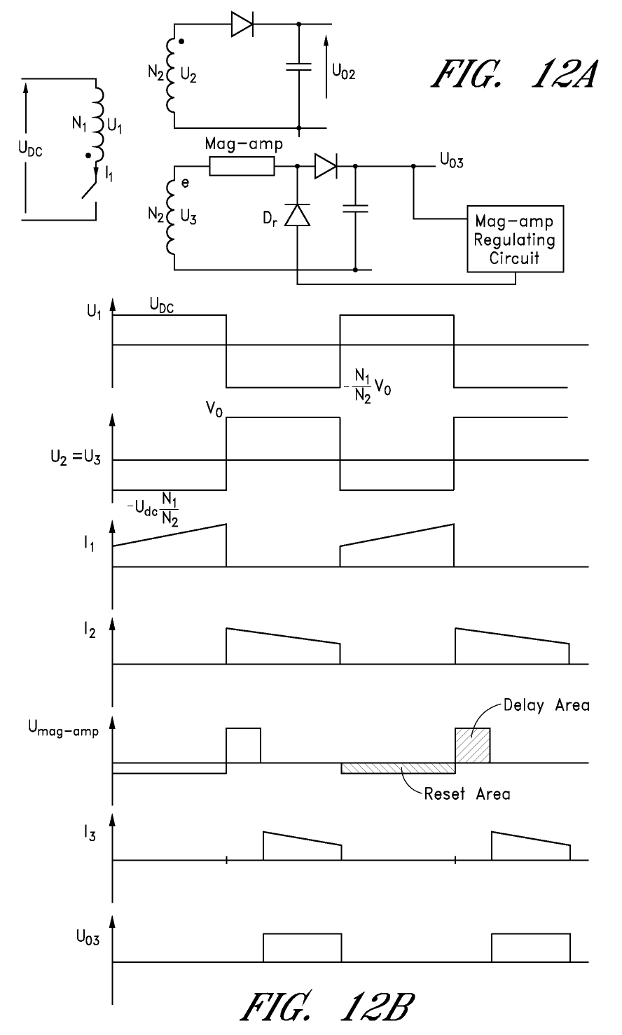

The voltage level is relatively important when charging lithium ion or lithium polymer batteries as these batteries are typically charged from a fixed voltage source that is current limited. This method is also referred to as constant voltage charging. The charger sources current into the battery in an attempt to force the battery voltage up to a pre-set value. Once this voltage is reached, the charger will preferably source only enough current to hold the voltage of the battery at this constant voltage. The accuracy on the set point voltage can be relatively important: if this voltage is too high, the number of charge cycles the battery can complete is reduced. If the voltage is too low, the battery cell will not be fully charged. FIG. 11 shows a typical charging profile for a lithium ion battery cell using 1 A-hr constant voltage charging. The constant voltage charging is divided into two phases. The current limited phase of charging is shown to the left of FIG. 11, wherein the maximum charging current (e.g., 1 A) is flowing into the battery; due to the battery voltage is below the reference voltage (e.g., 2.65 Volts). The charger senses this and sources maximum current to try to force the battery voltage up. During the current limited phase, the charger should limit the current to no more than the maximum allowed by the battery manufacturer to prevent damage to the battery cells. About 65% of the total charge is delivered to the battery during the current limited phase of the charging. The constant voltage of the charge cycle begins when the battery voltage sensed by the charger reaches about 4.2V (the normal set point for lithium ion batteries). At this point, the charger reduces the charging current to hold the sense voltage constant at 4.2V resulting in a current waveform that is shaped like an exponential decay.

Voltage regulator integrated circuits for controlling the charging voltage are readily available and many of these regulators have a built in current limit circuit. However, these regulator devices typically need voltage trim resistors to function. Resistors by themselves have tolerances and the cumulative effect of the components will contribute error to the set voltage. In addition to the component tolerances, the circuitry with the trim resistors will continuously drain current from the battery, and although the current is relatively minute (in the region of 10 uA), it does reduce the standby time for portable products. There are currently on market, battery charger controllers that source current from its output when the regulated voltage is applied from input to ground. These are higher precision devices that do not require external voltage trims. However, this still does not provide a solution for a proper closed-loop voltage control. Different portable device batteries or just batteries have very dissimilar current carrying capacity and their behavior will vary from one to the other. The charging characteristics of the charger should match with those of the battery cells, e.g., it is not advisable to use a charging device with a fixed current limit and voltage to charge a lithium polymer battery cell. It is therefore crucial for precise closed-loop control of the charging voltage and current.

Closed-loop control is typically used in normal wired-circuitries. In a wireless system, feedback of the control parameters, i.e., sense of voltages and currents, is not possible through a wired route. Some designers have attempted other means of communication such as Bluetooth or by magnetic data transfer. These techniques are typically not viable because the rate of transmission via these channels is not fast enough for a proper control bandwidth to be obtained. The resultant feedback system will typically be either too slow or unstable for instance, overshoot transients, which is not ideal in the case of battery charging. A magnetic amplifier is advantageously used in the feedback loop.

The dynamics of a fly-back converter will now be described. Electrical isolation is achieved through placing a second winding in the inductor of a buck-boost converter. When the switch is on, due to winding polarities, the diode becomes reverse biased. After, when the switch is turned off, the energy stored in the inductor core causes current to flow in the secondary winding through the diode. The function of a magnetic amplifier can be described as a high speed on/off switch similar to a switching transistor. The core of the magnetic amplifier is typically made up of a soft-magnetic alloy having a rectangular hysteresis loop. The magnetic amplifier is relatively open, i.e. not very conductive, when the core is magnetized and the current to the output is blocked. When the core material is saturated, the magnetic amplifier is on, i.e., relatively conductive, and current starts to flow to the output. This effect is based on a rapid change in impedance of the choke. This switching function can be used for pulse width control of the voltage pulse induced in the respective secondary winding before rectification. In one embodiment, intervention takes place at the leading edge of the pulse induced in the respective secondary winding (before the pulse is rectified and smoothed by the output filter).

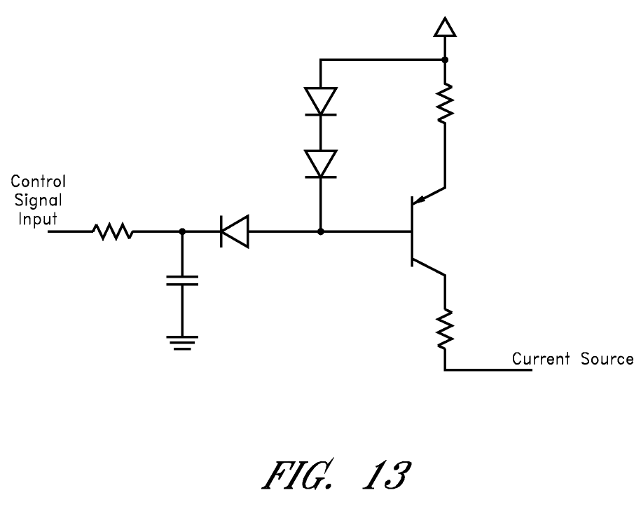

FIG. 12 provides an illustration of the operating principle when the magnetic amplifier is used in the fly-back circuit. FIG. 13 shows the detailed configuration of the current source generator where the control signal from the PID controller is translate into a useful current source signal to reset the magnetic amplifier. U1 is the voltage of the primary winding, U2 is the voltage of the secondary winding of a normal fly-back circuit and U3 is the voltage of the secondary winding that has a magnetic amplifier. As can be seen, the magnetic amplifier is placed in the circuit path before the rectification process through the diode. The closed-loop control mechanism is performed within the mag-amp regulating circuitry. Both the charging current and voltage can be regulated this way. When the reference value (current or voltage) is higher than the output value, the mag-amp regulating circuit will allow the magnetic amplifier to enter saturation to reduce the pulse delay by allowing more voltage to be rectified. On the other hand, when the reference value is lower than the output value, the mag-amp regulating circuit will produce a reset current in the opposite direction to the original current path that flows through the magnetic amplifier through diode D2 to reset the core of the magnetic amplifier, which then acts like an opened switch.

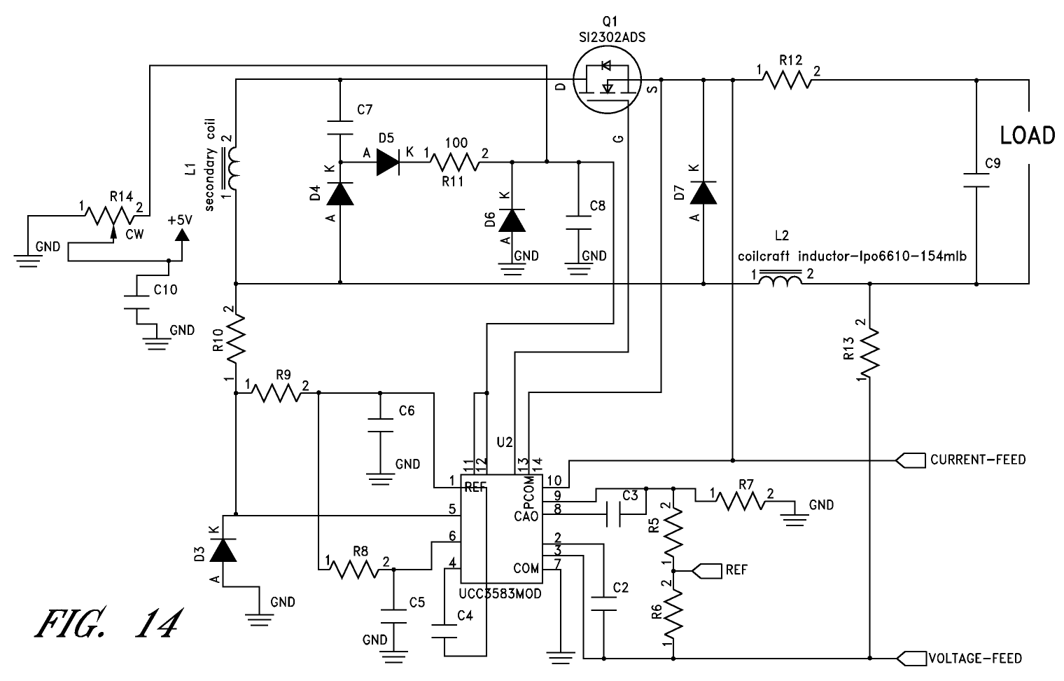

With the introduction of a magnetic amplifier or other control within the secondary circuit of the battery, multiple secondary closed-loop control can be achieved. For example, in one embodiment, rather than use the magnetic amplifier, a transistor, e.g., MOSFET, driven by a controller can be used to provide power or charging control. An example of such a controller is a switch mode secondary side post regulator with part number UCC3583 available from Unitrode Products. An example of such a circuit is illustrated in FIG. 14. In FIG. 14, Q1 is a MOSFET switch for control, and U2 is the controller chip. The controller chip U2 provides a gate drive for MOSFET Q1. Inductor symbol L1 represents a secondary winding for receiving wireless power. Various other components are for rectifying, current sensing, voltage sensing, and the like. Capacitor C9 can be coupled across the load in parallel, such as across a battery to be charged. The primary charging surface can provide a maximum duty ratio and the feedback control can be implemented accurately with, for example, a preprogrammed reference value within the microcontroller for various devices. For example, each rechargeable device, e.g., rechargeable battery pack or rechargeable portable device, can have its own locally regulated secondary circuit to provide relatively good charging performance from a shared primary charging surface.

Various embodiments have been described above. Although described with reference to these specific embodiments, the descriptions are intended to be illustrative and are not intended to be limiting. Various modifications and applications may occur to those skilled in the art.

What is claimed is:

1. An apparatus for providing wireless charging over a 3-dimensional space, the apparatus comprising:
at least 3 separate conductive windings, wherein each of the at least 3 separate conducive windings is configured to carry a separate electrical current for generation of a magnetic flux field over the 3-dimensional space; and
a control circuit coupled to the at least 3 separate conductive windings, the control circuit configured to generate at least 3 time-varying currents to be carried by the at least 3 separate conductive windings, wherein each of the at least 3 time-varying currents is operated at a different frequency from each other.

2. The apparatus of claim 1, wherein at least one of the currents generated by the control circuit is pulsed.

3. The apparatus of claim 1, wherein at least one of the currents generated by the control circuit is sinusoidal.

4. The apparatus of claim 1, further comprising a core of a magnetically permeable material, wherein at least one of the windings is wrapped around the core.

5. The apparatus of claim 1, wherein the control circuit is configured to generate the time-varying currents such that one of the currents is at a fundamental frequency and other currents are at integer multiples of the fundamental frequency.

6. The apparatus of claim 1, wherein a frequency for the time-varying currents is between about 10 kilohertz and 1 megahertz.

7. The apparatus of claim 1, wherein a fundamental frequency for the time-varying currents is at least 25 kilohertz.

8. The apparatus of claim 1, wherein the control circuit is configured to vary an amplitude of the time-varying currents for control of range.

9. A method for providing wireless charging over a 3-dimensional space, the method comprising:
providing at least 3 separate conductive windings, wherein each of the at least 3 separate conducive windings is configured to carry a separate electrical current for generation of a magnetic flux field over the 3-dimensional space; and
generating at least 3 time-varying currents for the at least 3 separate conductive windings, wherein each of the at least 3 time-varying currents is operated at a different frequency from each other.

10. The method of claim 9, further comprising generating at least one of the currents in a pulsed manner.

11. The method of claim 9, further comprising generating at least one of the currents in a sinusoidal manner.

12. The method of claim 9, wherein at least one of the windings is wrapped around a core of magnetically permeable material comprising at least one of ferrite, ferromagnetic, nanocrystalline, or powdered iron.

13. The method of claim 9, wherein the generating the time-varying currents such that one of the currents is at a fundamental frequency and other currents are at integer multiples of the fundamental frequency.

14. The method of claim 9, wherein a frequency for the time-varying currents is between about 10 kilohertz and 1 megahertz.

15. The method of claim 9, wherein a fundamental frequency for the time-varying currents is at least 25 kilohertz.

16. The method of claim 9, further comprising varying an amplitude of the time-varying currents for control of range.
